(19) United States
(12) Patent Application Publication
(10) Pub. No.: US 2021/0302002 A1
(43) Pub. Date: Sep. 30, 2021

(54) VENTILATION MEMBER FOR VEHICLE LAMP AND MANUFACTURING METHOD THEREOF

(71) Applicants: HYUNDAI MOBIS CO., LTD., Seoul (KR); AMOGREENTECH CO., LTD., Gimpo-si (KR)

(72) Inventors: Jin Won LEE, Yongin-si (KR); Young Ho LEE, Yongin-si (KR); Jun Keun CHO, Gimpo-si (KR); Kyoung Taek PARK, Gimpo-si (KR); Hyoung Joo KIM, Gimpo-si (KR); Sang Yeop SHIM, Gimpo-si (KR); Sung Pil CHO, Gimpo-si (KR)

(73) Assignees: HYUNDAI MOBIS CO., LTD., Seoul (KR); AMOGREENTECH CO., LTD., Gimpo-si (KR)

(21) Appl. No.: 17/212,197

(22) Filed: Mar. 25, 2021

(30) Foreign Application Priority Data
Mar. 27, 2020 (KR) 10-2020-0037570

(51) Int. Cl. F21S 45/30; D04H 1/728; D04H 1/587; D01D 5/00

(52) U.S. Cl. CPC F21S 45/30; D04H 1/728; D10B 2505/12; D01D 5/003; D04H 1/587

(57) ABSTRACT

Provided is a ventilation member for a vehicle lamp. The ventilation member includes a nanofiber membrane, a composite adhesive layer stacked on one surface of the nanofiber membrane, and a ventilation structure provided in a central portion of the composite adhesive layer and in contact with the nanofiber membrane. The composite adhesive layer includes an acrylic adhesive layer in contact with the nanofiber membrane and a silicone-based adhesive layer provided on one surface of the acrylic adhesive layer. The acrylic adhesive layer is in contact with the nanofiber membrane, the acrylic adhesive layer is infiltrated into the nanofiber membrane to a depth of 30 μm or more. The ventilation member for a vehicle lamp has a water pressure resistance of 1.0 bar or more.

### CROSS-REFERENCE TO RELATED APPLICATION

This application claims the benefit of Korean Patent Application No. 10-2020-0037570, filed on Mar. 27, 2020 in the Korean Intellectual Property Office, the entire disclosures of which are incorporated herein by reference.

### BACKGROUND

### Field

Exemplary embodiments of the present disclosure relate to a ventilation member for a vehicle lamp and a manufacturing method thereof.

### Discussion of the Background

A vehicle lamp has an open structure that may be ventilated in order to solve increases in temperature and air pressure within the lamp when the vehicle lamp is turned on. Thus, condensation occurs in the lamp due to the differences in temperature and moisture between the outside and the inside of the lamp.

When condensation repetitively occurring within the vehicle lamp is not solved, the performance of the lamp may be degraded or electrical insulation of the lamp may be reduced, thereby having an adverse effect on the safety of an occupant. Accordingly, the vehicle lamp has a ventilation member, such as a ventilation patch, attached thereto. The ventilation member serves to prevent condensation, maintain the pressure equilibrium between the inside and the outside of the lamp, and prevent introduction of impurities or moisture from the outside. For example, the ventilation member, such as a ventilation patch, may be attached to a ventilation structure provided on one side of the vehicle lamp.

However, such a ventilation member of the related art has insufficient adhesion to a vehicle lamp and low durability and water pressure resistance. Thus, problems arise in that external moisture may easily infiltrate into the ventilation member even at low water pressure, thereby reducing the durability or performance of the lamp.

A background art relating to the present disclosure is disclosed in Korean Patent No. 10-1812784 (patented on Dec. 27, 2017, titled “WATERPROOF VENTILATION SEAT AND MANUFACTURING METHOD THEREOF”).

### SUMMARY

An objective of the present disclosure is directed to a ventilation member for a vehicle lamp, the ventilation member having excellent durability and water pressure resistance due to excellent adhesion between a lamp material and a nanofiber membrane.

Another objective of the present disclosure is directed to a ventilation member for a vehicle lamp having excellent water resistance, dust resistance, and air permeability.

Still another objective of the present disclosure is directed to a manufacturing method of the above-described ventilation member fora vehicle lamp.

An aspect of the present disclosure relates to a ventilation member for a vehicle lamp. The ventilation member may include: a nanofiber membrane; a composite adhesive layer stacked on one surface of the nanofiber membrane; and a ventilation structure provided in a central portion of the composite adhesive layer and in contact with the nanofiber membrane. The composite adhesive layer may include an acrylic adhesive layer in contact with the nanofiber membrane and a silicone-based adhesive layer provided on one surface of the acrylic adhesive layer. The acrylic adhesive layer may be in contact with the nanofiber membrane, the acrylic adhesive layer is infiltrated into the nanofiber membrane to a depth of 30 μm or more. The ventilation member for a vehicle lamp may have a water pressure resistance of 1.0 bar or more.

In one embodiment, the nanofiber membrane may be manufactured by thermally-fusing a nanofiber web formed by electrospinning a spinning solution containing polyvinylidene fluoride.

In one embodiment, the he nanofiber membrane may have a fiber diameter ranging from 50 nm to 500 nm and a porosity ranging from 10% to 80%.

In one embodiment, the acrylic adhesive layer may be infiltrated into the nanofiber membrane to a depth ranging from 30 μm to 80 μm.

In one embodiment, the nanofiber membrane may have a thickness ranging from 30 μm to 150 μm. The composite adhesive layer may have a thickness ranging from 50 μm to 300 μm.

In one embodiment, the thickness of the nanofiber membrane and a total thickness of the silicone-based adhesive layer and the acrylic adhesive layer may have a thickness ratio ranging from 1:0.3 to 1:0.8.

In one embodiment, the silicone-based adhesive layer and the acrylic adhesive layer may have a thickness ratio ranging from 1:0.5 to 1:4.

In one embodiment, the composite adhesive layer may further include a carrier layer provided between the acrylic adhesive layer and the silicone-based adhesive layer.

In one embodiment, the composite adhesive layer may be formed in an area ranging 55% to 80% of a total area of the one surface of the nanofiber membrane.

In a specific embodiment, at 70 mbar, the nanofiber membrane may have an air permeability of 25 L/h or more and a moisture vapor transmission rate exceeding 850 mg moisture/day.

Another aspect of the present disclosure relates to a manufacturing method of a ventilation member for a vehicle lamp. The manufacturing method may include forming a composite adhesive layer by thermally-laminating a composite adhesive member to one surface of a nanofiber membrane. The composite adhesive member may include an acrylic adhesive layer in contact with the nanofiber membrane and a silicone-based adhesive layer provided on one surface of the acrylic adhesive layer. In the thermal lamination, the acrylic adhesive layer may infiltrate into the nanofiber membrane to a depth of 30 μm or more.

In one embodiment, the thermal lamination may be performed in a temperature ranging from 120° C. to 140° C.

In one embodiment, the nanofiber membrane may be formed by forming a nanofiber web by electrospinning a spinning solution containing polyvinylidene fluoride and thermally-fusing the nanofiber web.

In one embodiment, thermally-fusing the nanofiber web comprises performing a thermal fusion in a temperature ranging from 60° C. to 150° C.

The ventilation member for a vehicle lamp according to the present disclosure may have excellent adhesion between a lamp material and a nanofiber membrane, have excellent durability and water pressure resistance, and have excellent water resistance, dust resistance, and air permeability.

### BRIEF DESCRIPTION OF THE DRAWINGS

FIG. 1 is a cross-sectional view illustrating a ventilation member for a vehicle lamp according to one embodiment of the present disclosure;

FIG. 2 is a plan view illustrating the ventilation member for a vehicle lamp according to one embodiment of the present disclosure;

FIG. 3 is a view schematically illustrating a method of measuring the water pressure resistance of the ventilation member for a vehicle lamp according to the present disclosure;

FIG. 4 is an SEM image illustrating a nanofiber membrane according to Example 1 of the present disclosure;

FIG. 5 is an SEM image of the depth of an acrylic adhesive layer infiltrated into a nanofiber membrane according to Comparative Example 1;

FIG. 6 is an image of a ventilation member for a vehicle lamp according to Example 1; and

FIG. 7 is an image of the ventilation member fora vehicle lamp according to Example 1 attached to a vehicle lamp.

### DETAILED DESCRIPTION OF THE ILLUSTRATED EMBODIMENTS

In the following description of the present disclosure, detailed descriptions of related publicly-known technologies and configurations will be omitted in the situation in which it is determined that the subject matter of the present disclosure may be rendered rather unclear thereby.

In addition, terms used herein are defined in consideration of functions thereof in the present disclosure, but may vary depending on the intentions of users or operators, or practices. Therefore, the terms shall be defined on the basis of the description throughout the specification.

A term “(meth)acryl” used herein may refer to at least one of “acryl” and “methacryl.”

### Ventilation Member for Vehicle Lamp

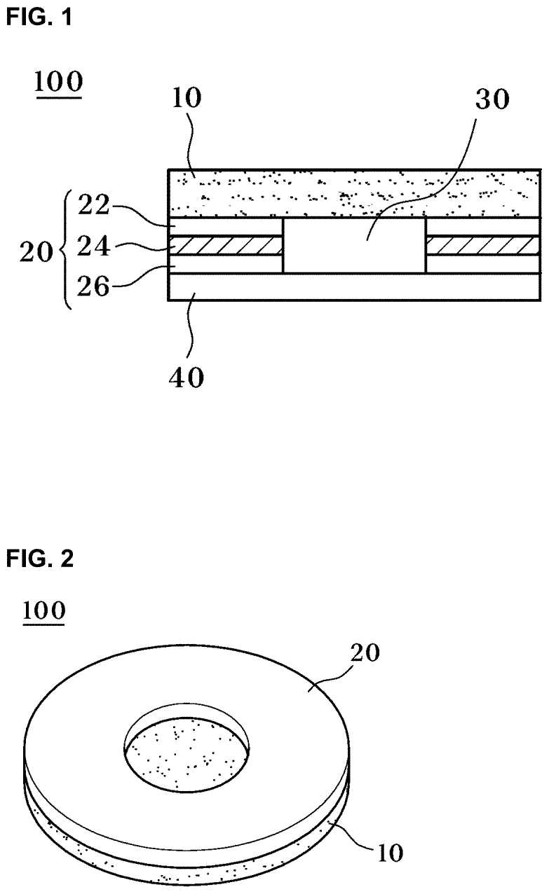

An aspect of the present disclosure relates to a ventilation member for a vehicle lamp. FIG. 1 is a cross-sectional view illustrating a ventilation member for a vehicle lamp according to one embodiment of the present disclosure, and FIG. 2 is a plan view illustrating the ventilation member for a vehicle lamp according to one embodiment of the present disclosure.

Referring to FIGS. 1 and 2, the ventilation member 100 for a vehicle lamp includes: a nanofiber membrane 10; a composite adhesive layer 20 stacked on one surface of the nanofiber membrane 10; and a ventilation structure 30 provided in the central portion of the composite adhesive layer 20 and in contact with the nanofiber membrane 10.

In a specific embodiment, the longitudinal cross-section of the nanofiber membrane 10 may have the shape of a circle, a rectangle, or a polygon.

In a specific embodiment, the composite adhesive layer 20 includes an acrylic adhesive layer 22 in contact with the nanofiber membrane 10 and a silicone-based adhesive layer 26 provided on one surface of the acrylic adhesive layer 22. The acrylic adhesive layer 22 is infiltrated into the nanofiber membrane 10 to a depth of 30 μm or more. In a specific embodiment, the silicone-based adhesive layer 26 may be attached to a surface on which the lamp is to be mounted.

In one embodiment, the acrylic adhesive layer may contain alkyl (meth)acrylate. For example, the alkyl (meth)acrylate may include one or more from among methyl (meth)acrylate, ethyl (meth)acrylate, propyl (meth)acrylate, butyl (meth)acrylate, pentyl (meth)acrylate, hexyl (meth)acrylate, ethylhexyl(meth)acrylate, heptyl(meth)acrylate, octyl (meth)acrylate, nonyl (meth)acrylate, decyl (meth)acrylate, lauryl (meth)acrylate, and dodecyl (meth)acrylate. When the acrylic adhesive layer contains one or more from among the above-mentioned compounds, the acrylic adhesive layer may easily infiltrate into the nanofiber membrane, and the ventilation member may have excellent durability.

For example, the acrylic adhesive layer may be formed by using an adhesive composition including methyl (meth)acrylate.

In one embodiment, the silicone-based adhesive layer may contain one or more from among an epoxy silane compound, an aminosilane compound, a vinyl silane compound, a halosilane compound, a (meth)acryloxy silane compound, and an isocyanate silane compound. When the silicone-based adhesive layer contains one or more of the above-mentioned compounds, the silicone-based adhesive layer may have excellent adhesion to a vehicle lamp member.

For example, the silicone-based adhesive layer may be formed by using an adhesive composition including dichlorodimethylsilane.

Referring to FIG. 1, a release layer 40 may be provided on one surface of the silicone-based adhesive layer 26 and prevent the silicone-based adhesive layer 26 from being contaminated or the adhesion of the silicone-based adhesive layer 26 from being reduced.

In one embodiment, the area of the composite adhesive layer may be 55% to 80% of a total area of one surface of the nanofiber membrane. In this condition, adhesion between the nanofiber membrane and the composite adhesive layer may be excellent, and the ventilation member according to the present disclosure may have excellent durability and water pressure resistance. For example, the area of the composite adhesive layer may be 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, or 80% of the total area of one surface of the nanofiber membrane.

In one embodiment, the nanofiber membrane 10 may be manufactured by thermally fusing a nanofiber web formed by electrospinning a spinning solution including polyvinylidene fluoride (PVDF).

The spinning solution may include PVDF and a solvent. When the electrospinned nanofiber web is thermally fused, the nanofiber membrane forms a three-dimensional (3D) multilayer structure. Accordingly, the nanofiber membrane may have excellent durability, air permeability, and water pressure resistance. In addition, when water penetrates into the nanofiber membrane, respective layers of the nanofiber web may block the penetration of water, and thus the nanofiber membrane may have excellent water pressure resistance performance.

In one embodiment, the nanofiber membrane 10 may have a fiber diameter ranging from 50 nm to 500 nm and a porosity ranging from 10% to 80%. In this condition, the nanofiber membrane 10 may have excellent air permeability and durability, prevent the difference in pressure between the inside and the outside of the vehicle lamp, and prevent water leakage through the nanofiber membrane due to excellent water pressure resistance.

In one embodiment, the acrylic adhesive layer is infiltrate into the nanofiber membrane to a depth of 30 μm or more.

The term “infiltration” used herein means that the components of the acrylic adhesive layer are fused by thermal lamination so as to penetrate into spaces between pores in the nanofiber membrane.

When the acrylic adhesive layer is infiltrate into the nanofiber membrane to a depth less than 30 μm, the adhesion between the nanofiber membrane and the acrylic adhesive layer is reduced. Thus, the ventilation member according to the present disclosure may not obtain an intended level of durability and water pressure resistance. For example, the acrylic adhesive layer may infiltrate into the nanofiber membrane to a depth ranging from 30 μm to 80 μm. For example, the acrylic adhesive layer may infiltrate into the nanofiber membrane to a depth of 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, 50 μm, 51 μm, 52 μm, 53 μm, 54 μm, 55 μm, 56 μm, 57 μm, 58 μm, 59 μm, 60 μm, 61 μm, 62 μm, 63 μm, 64 μm, 65 μm, 66 μm, 67 μm, 68 μm, 69 μm, 70 μm, 71 μm, 72 μm, 73 μm, 74 μm, 75 μm, 76 μm, 77 μm, 78 μm, 79 μm, or 80 μm.

In one embodiment, the thickness of the nanofiber membrane may range from 30 μm to 150 μm. In this thickness range, the nanofiber membrane may have excellent durability and water pressure resistance.

In one embodiment, the thickness of the composite adhesive layer may range from 50 μm to 300 μm. In this thickness range, the composite adhesive layer may have excellent durability and water pressure resistance.

Referring to FIG. 1, the composite adhesive layer 20 may further include a carrier layer 24 provided between the acrylic adhesive layer 22 and the silicone-based adhesive layer 26. In one embodiment, the carrier layer 24 may contain polyethylene terephthalate. When the carrier layer is provided, the durability and the water pressure resistance of the composite adhesive layer may be increased.

Referring to FIG. 1, the thickness of the nanofiber membrane and the total thickness of the silicone-based adhesive layer and the acrylic adhesive layer may have a thickness ratio ranging from 1:0.3 to 1:0.8. Here, the thickness of the acrylic adhesive layer does not include the portion of the acrylic adhesive layer infiltrated into the nanofiber membrane. In this range of the thickness ratio, both adhesion to the surface of the lamp and adhesion to the nanofiber membrane may be excellent, and degradations in the performance, such as water resistance and water pressure resistance, of the ventilation member due to changes in the temperature and the moisture may be minimized. For example, the thickness ratio may range from 1:0.5 to 1:0.8. Here, the thickness of the acrylic adhesive layer does not include the portion of the acrylic adhesive layer infiltrated into the nanofiber membrane.

In one embodiment, the silicone-based adhesive layer and the acrylic adhesive layer may have a thickness ratio ranging from 1:0.5 to 1:4. In the this range of the thickness ratio, both adhesion to the surface of the lamp and adhesion to the nanofiber membrane may be excellent, and thus water resistance and water pressure resistance of the ventilation member may be excellent.

Here, the thickness of the acrylic adhesive layer does not include the portion of the acrylic adhesive layer infiltrated into the nanofiber membrane.

For example, the silicone-based adhesive layer and the acrylic adhesive layer may have a thickness ratio ranging from 1:0.5 to 1:3.

In one embodiment, the thickness of the carrier layer 24 may range from 10 μm to 100 μm. In this thickness range, the durability and the water pressure resistance of the composite adhesive layer may be increased.

In one embodiment, at 70 mbar, the nanofiber membrane may have an air permeability of 25 L/h or more and a moisture vapor transmission rate (MVTR) exceeding 850 mg moisture/day. For example, at 70 mbar, the nanofiber membrane may have a value air permeability ranging from 25 L/h to 50 L/h and an MVTR ranging from 860 mg moisture/day to 2000 mg moisture/day.

In one embodiment, the water pressure resistance of the nanofiber membrane and the composite adhesive layer is 1.0 bar or more. When the water pressure resistance is less than 1.0 bar, the water pressure resistance intended in the present disclosure may not be obtained. For example, the water pressure resistance may range from 1.0 bar to 8.0 bar. For example, the water pressure resistance may be 1 bar, 2 bar, 3 bar, 4 bar, 5 bar, 6 bar, 7 bar, or 8 bar.

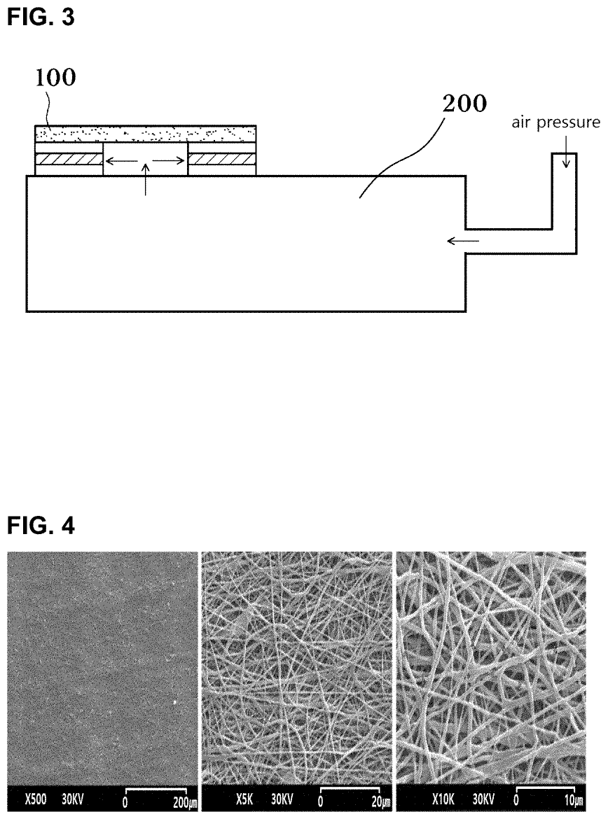

FIG. 3 is a view schematically illustrating a method of measuring the water pressure resistance of the ventilation member for a vehicle lamp according to the present disclosure. Referring to FIG. 3, the method of measuring the water pressure resistance may be performed by preparing a measuring module 200 having 10 cc capacity and a 1.5 cm-diameter hole formed in the top surface thereof, filling the measuring module 200 with water, attaching the nanofiber membrane to the hole, and measuring a pressure at which water leaks as the nanofiber membrane is torn or the composite adhesive layer of the patch is ruptured while increasing the water pressure by applying air pressure into the measuring module.

The measuring module used may be formed of a material including PC-ABS or PC. When the water pressure resistance is less than 1.0 bar, the water pressure resistance intended in the present disclosure may not be obtained. For example, the water pressure resistance may range from 1.0 bar to 8.0 bar. For example, the water pressure resistance may be 1 bar, 2 bar, 3 bar, 4 bar, 5 bar, 6 bar, 7 bar, or 8 bar.

### Manufacturing Method of Ventilation Member for Vehicle Lamp

Another aspect of the present disclosure relates to a manufacturing method of a ventilation member for a vehicle lamp. In a specific embodiment, the manufacturing method of a ventilation member for a vehicle lamp includes a step of forming a composite adhesive layer by thermally-laminating a composite adhesive member to one surface of a nanofiber membrane.

The composite adhesive member includes an acrylic adhesive layer in contact with the nanofiber membrane and a silicone-based adhesive layer formed on a surface of the acrylic adhesive layer. During the thermal lamination, the acrylic adhesive layer infiltrates into the nanofiber membrane to a depth of 30 μm or more. When the depth of infiltration is less than 30 μm, the water pressure resistance and the durability of the ventilation member may be reduced.

In a specific embodiment, the thermal lamination may be performed in a temperature ranging from 120° C. to 140° C. When the thermal lamination is performed in this condition, at least a portion of the acrylic adhesive layer may infiltrate into the nanofiber membrane, thereby improving the water pressure resistance and the durability of the ventilation member. For example, the thermal lamination may be performed at a rate ranging from 1 m/min to 10 m/min in a temperature ranging from 120° C. to 140° C.

In a specific embodiment, the nanofiber membrane may be formed by a step of forming a nanofiber web by electrospinning a spinning solution containing polyvinylidene fluoride (PVDF) and a step of thermally-fusing the nanofiber web.

In a specific embodiment, thermally-fusing the nanofiber web comprises performing a thermal fusion in a temperature ranging from 60° C. to 150° C. In this condition, a nanofiber membrane having a three-dimensional (3D) multilayer structure may be easily formed.

Hereinafter, configurations and operations of the present disclosure will be described in more detail with respect to preferred examples of the present disclosure. However, it should be noted that these examples are presented as preferred examples of the present disclosure and should not be construed in any way as limiting the present disclosure. The contents that are not described herein can be sufficiently and technically envisioned by those skilled in the art, and thus the description thereof will be omitted herein.

### EXAMPLES AND COMPARATIVE EXAMPLE Example 1

A nanofiber membrane (having water pressure resistance of 5 bar, and at 70 mbar, air permeability of 25 L/h or more and MVTR exceeding 850 mg moisture/day) having a circular longitudinal cross-section and a thickness of 100 μm, as illustrated in FIG. 4, was manufactured by forming a nanofiber web by electrospinning a spinning solution containing PVDF and thermally-fusing the nanofiber web in a temperature ranging from 60° C. to 150° C.

Afterwards, a ventilation member for a vehicle lamp was manufactured by preparing a composite adhesive member in which an acrylic adhesive layer (containing methyl (meth)acrylate), a carrier layer formed of PET, and a silicone-based adhesive layer (containing dichlorodimethylsilane) are sequentially stacked, forming a composite adhesive layer by thermally-laminating the composite adhesive member to one surface of the nanofiber membrane at a rate ranging from 1 m/min to 10 m/min in a temperature ranging from 120° C. to 140° C., and forming a ventilation structure located in the central portion of the composite adhesive layer and in contact with the nanofiber membrane. In the thermal lamination, the acrylic adhesive layer infiltrated into the nanofiber membrane to a depth of 30 μm. The composite adhesive layer was formed of the acrylic adhesive layer (except for a portion infiltrated into the nanofiber membrane) having a thickness of 30 μm, the carrier layer having a thickness of 50 μm and formed of PET, and the silicone-based adhesive layer having a thickness of 40 μm.

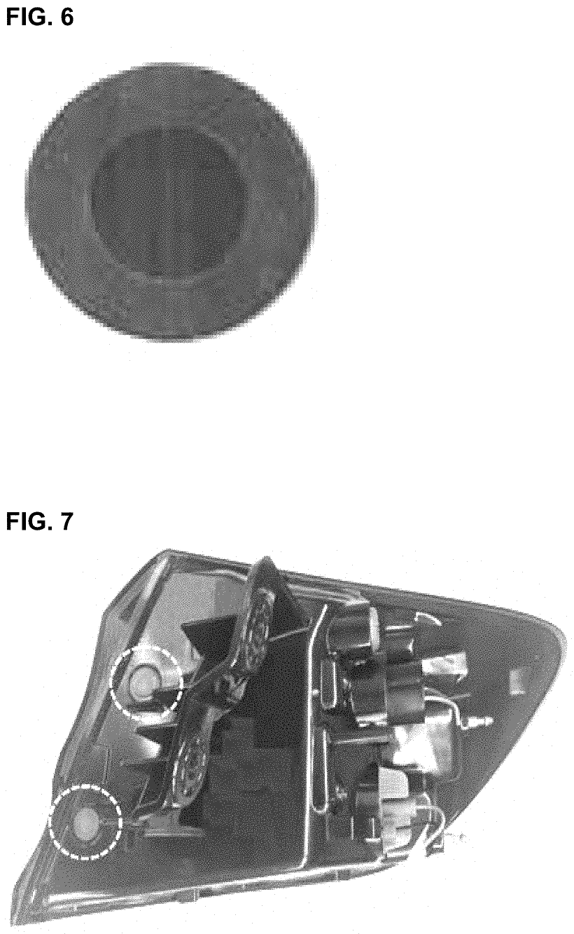

FIG. 6 is an image of the ventilation member fora vehicle lamp according to Example 1, and FIG. 7 is an image of the ventilation member for a vehicle lamp according to Example 1 attached to a vehicle lamp.

The depth to which the acrylic adhesive layer is infiltrated was measured using a scanning electron microscope (SEM). In addition, the area of the composite adhesive layer formed was 68.7% of the total area of one surface of the nanofiber membrane.

### Examples 2 and 3 and Comparative Example

The ventilation member was manufactured by the same method as of Example 1, except that the ventilation member was manufactured by performing thermal lamination at infiltration thicknesses of the acrylic adhesive as illustrated in Table 1.

Measurement of Water Pressure Resistance: The measuring module 200 having 10 cc capacity and a 1.5 cm-diameter hole formed in the top surface thereof was filled with water, each of ventilation patches according to Examples and Comparative Example was brought into contact with the hole, and a silicone-based adhesive layer of the ventilation patch was attached to the measuring module by pressing peripheral portions of the ventilation patch using jigs and maintaining the ventilation patch in this position for 30 minutes at room temperature. Afterwards, air pressure (water pressure resistance) at which water leaks as the nanofiber membrane was torn or the composite adhesive layer of the patch was ruptured was measured while increasing the pressure of water by applying air pressure into the measuring module. Results thereof are illustrated in Table 1 below.

TABLE 1

| | Total | Infiltration | Measurement |
|---|---|---|---|
| | Thickness of | Thickness of | Result of Water |
| | Ventilation | Acrylic Adhesive | Pressure |
| Examples | Member (μm) | Layer (μm) | Resistance (bar) |
| Example 1 | 220 | 30 | 1.0 |
| Example 2 | 200 | 50 | 2.0 |
| Example 3 | 180 | 70 | 2.5 |
| Comparative | 240 | 10 | 0.7 |
| Example | | | |

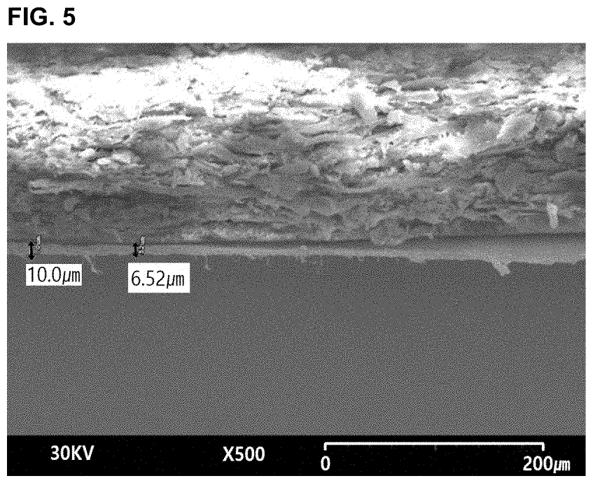

FIG. 5 is an SEM image of the depth of the acrylic adhesive layer infiltrated into the nanofiber membrane according to the Comparative Example. Referring to the results of FIG. 5 and Table 1, it can be seen that, in the Comparative Example in which the infiltration depth of the acrylic adhesive layer is less than the infiltration depth of the acrylic adhesive layer according to the present disclosure, the water pressure resistance was significantly reduced to 0.7 bar.

In contrast, it can be seen that, in Examples 1 to 3, the water pressure resistance of each ventilation member was 1.0 bar or more, and thus the ventilation member had excellent water resistance and water pressure resistance and could be suitable for a ventilation member for a vehicle lamp.

The present disclosure has been described hereinabove with respect to the specific embodiments thereof. It will be understood by those skilled in the art to which the present disclosure pertains that the present disclosure may be implemented in modified forms without departing from the essential features of the present disclosure. Thus, the foregoing embodiments disclosed herein shall be considered as being illustrative while not being limitative. It should be understood that the scope of the present disclosure shall not be defined by the foregoing description but by the appended Claims and all differences equivalent to the Claims belong to the present disclosure.

What is claimed is:

1. A ventilation member for a vehicle lamp, the ventilation member comprising:
a nanofiber membrane;
a composite adhesive layer stacked on one surface of the nanofiber membrane; and
a ventilation structure provided in a central portion of the composite adhesive layer and in contact with the nanofiber membrane,
wherein the composite adhesive layer comprises an acrylic adhesive layer in contact with the nanofiber membrane and a silicone-based adhesive layer provided on one surface of the acrylic adhesive layer,
the acrylic adhesive layer is in contact with the nanofiber membrane,
the acrylic adhesive layer is infiltrated into the nanofiber membrane to a depth of 30 μm or more, and
the ventilation member for a vehicle lamp has a water pressure resistance of 1.0 bar or more.

2. The ventilation member of claim 1, wherein the nanofiber membrane is manufactured by thermally-fusing a nanofiber web formed by electrospinning a spinning solution containing polyvinylidene fluoride.

3. The ventilation member of claim 1, wherein the nanofiber membrane has a fiber diameter ranging from 50 nm to 500 nm and a porosity ranging from 10% to 80%.

4. The ventilation member of claim 1, wherein the acrylic adhesive layer is infiltrated into the nanofiber membrane to a depth ranging from 30 μm to 80 μm.

5. The ventilation member of claim 1, wherein the nanofiber membrane has a thickness ranging from 30 μm to 150 μm, and
the composite adhesive layer has a thickness ranging from 50 μm to 300 μm.

6. The ventilation member of claim 1, wherein a thickness of the nanofiber membrane and a total thickness of the silicone-based adhesive layer and the acrylic adhesive layer have a thickness ratio ranging from 1:0.3 to 1:0.8.

7. The ventilation member of claim 1, wherein the silicone-based adhesive layer and the acrylic adhesive layer have a thickness ratio ranging from 1:0.5 to 1:4.

8. The ventilation member of claim 1, wherein the composite adhesive layer further comprises a carrier layer provided between the acrylic adhesive layer and the silicone-based adhesive layer.

9. The ventilation member of claim 1, wherein the composite adhesive layer is formed in an area ranging 55% to 80% of a total area of the one surface of the nanofiber membrane.

10. The ventilation member of claim 1, wherein, at 70 mbar, the nanofiber membrane has an air permeability of 25 L/h or more and a moisture vapor transmission rate exceeding 850 mg moisture/day.

11. A manufacturing method of a ventilation member for a vehicle lamp, the manufacturing method comprising:
forming a composite adhesive layer by thermally-laminating a composite adhesive member to one surface of a nanofiber membrane,
wherein the composite adhesive member comprises an acrylic adhesive layer in contact with the nanofiber membrane and a silicone-based adhesive layer provided on one surface of the acrylic adhesive layer, and
in the thermal lamination, the acrylic adhesive layer infiltrates into the nanofiber membrane to a depth of 30 μm or more.

12. The manufacturing method of claim 11, wherein the thermal lamination is performed in a temperature ranging from 120° C. to 140° C.

13. The manufacturing method of claim 11, wherein the nanofiber membrane is formed by forming a nanofiber web by electrospinning a spinning solution containing polyvinylidene fluoride and thermally-fusing the nanofiber web.

14. The manufacturing method of claim 13, wherein thermally-fusing the nanofiber web comprises performing a thermal fusion in a temperature ranging from 60° C. to 150° C.
